(19) United States
(12) Patent Application Publication
(10) Pub. No.: US 2011/0106370 A1
(43) Pub. Date: May 5, 2011

(54) METHOD AND SYSTEM FOR DRIVER STYLE MONITORING AND ANALYSING

(75) Inventors: Ashley Robert Duddle, Hampshire (GB); Stephen H. Perham, Surrey (GB)

(73) Assignee: AIRMAX GROUP PLC, Dorset (GB)

(21) Appl. No.: 12/282,822

(22) PCT Filed: Mar. 14, 2007
(86) PCT No.: PCT/GB2007/000895

§ 371 Date: Sep. 18, 2009

(30) Foreign Application Priority Data
Mar. 14, 2006 (GB) 0605069.4

(51) Int. Cl. G06Q 40/00; G06F 7/00

(52) U.S. Cl. 701/33; 705/4; 705/1.1

(57) ABSTRACT

The invention discloses a method and a system for determining insurance costs for a driver of a vehicle (100) comprising monitoring the location of the vehicle whilst it is being driven by the driver, monitoring parameters associated with the vehicle whilst it is being driven by the driver, generating a driver profile (400) that indicates the driving style of the driver based upon the location of the vehicle (100) and the parameters associated with the vehicle whilst it is being driven and determining insurance costs or charges using the driver profile. Determining costs associated with how a driver drives enables a driver to pay more fairly determined costs based on how well they drive, as they will not have to pay extra money for drivers who do not drive as well as them.

### FIELD OF THE INVENTION

This invention relates to a method and a system for driver style monitoring and analysing. In particular, but not exclusively, it relates to determining the costs associated with pay as you drive, pay how you drive, pay how you pollute, pay how you congest etc., all related to where, when and/or in what conditions/circumstances a vehicle is driven. The invention can also relate to training a driver in order to improve how safely and economically a vehicle is driven.

### BACKGROUND OF THE INVENTION

It is known to monitor where and when a user drives a vehicle using a global positioning system (GPS) located in the vehicle. The route that a driver takes can be mapped out using coordinates returned by the GPS system in combination with the times at which the coordinates were recorded.

### SUMMARY OF THE INVENTION

An aspect of the invention comprises a method for determining insurance costs or charges for a driver of a vehicle comprising:
monitoring the location of the vehicle whilst it is being driven by the driver;
monitoring parameters associated with the vehicle whilst it is being driven by the driver;
generating a driver profile that indicates the driving style of the driver based upon the location of the vehicle and the parameters associated with the vehicle whilst it is being driven; and
determining insurance costs or charges using the driver profile.

An aspect of the invention comprises a system for determining insurance costs or charges for a driver of a vehicle comprising:
a vehicle positioning device for monitoring the location of the vehicle whilst it is being driven by the driver;
a device for monitoring parameters associated with the vehicle whilst it is being driven by the driver; and
a processor arranged to:
   generate a driver profile that indicates the driving style of the driver based upon the location of the vehicle and the parameters associated with the vehicle whilst it is being driven; and
   determine insurance costs or charges using the driver profile.

An aspect of the invention comprises a method for calculating pollution charges for a driver comprising:
monitoring parameters associated with the vehicle whilst it is being driven by the driver;
generating a driver profile that indicates the driving style of the driver based upon the location of the vehicle and the parameters associated with the vehicle whilst it is being driven; and
determining pollution charges using the driver profile.

In alternative embodiments, the insurance costs or pollution charges may be any costs that a driver must pay to use their vehicle, for example insurance charges, taxes such as road tax, congestion charges, pollution taxes etc,

Determining costs associated with how a driver drives enables a driver to pay more fairly determined costs based on how well they drive, as they will not have to pay extra money for drivers who do not drive as well them. Also, the body that collects the charges (for example an insurance company, a local council or the government) can manage their charges better as they can better control how and where their income is coming from. For example, an insurance company can control how much risk they want to take on with their clients.

An aspect of the invention comprises a method of training a driver of a vehicle comprising:
monitoring the location of the vehicle whilst it is being driven by the driver;
monitoring parameters associated with the vehicle whilst it is being driven by the driver;
generating a driver profile that indicates the driving style of the driver based upon the location of the vehicle and the parameters associated with the vehicle whilst it is being driven; and
providing feedback to the driver using the driver profile.

The driver profile may be used to reward or penalise a driver. The location of the vehicle and the style in which the vehicle is being driven may be monitored in real time, or substantially in real time.

The method can be used to train a driver by providing feedback to the driver on how well he drives and his driving style. The method may be used to improve the safety, economy (minimising fuel consumption) and how much pollution is produced when a driver drives a vehicle. Pollution may be considered in terms of exhaust emissions, and may be quantified by the amount of carbon dioxide (CO₂) in the exhaust emissions, for example.

The driving style is a description of how a vehicle is driven by a driver. The driving style can be determined by evaluating parameters associated with the vehicle, for example the revolution speed of the engine may be evaluated to determine how steadily the vehicle is being driven, the deceleration of the vehicle may be evaluated to determine how hard the driver is braking, etc.

It may be possible to use engine management systems that are already present in a vehicle to help determine the driving style with which a vehicle is being driven. Information that may be obtained from the engine management system can include, but is not limited to: revolutions per minute (RPM); speed; distance; acceleration; deceleration; fuel consumption/usage; miles per gallon (mpg); throttle position; gear the vehicle is being driven in; gear ratio; idle ratio, and any faults associated with the vehicle. One, some, or all of the above parameters may be used to generate a profile of the driver.

Using data obtained from the engine management system to determine the style with which a driver drives their vehicle can help provide a fine granularity as to how safe the driver is. Improved performance monitoring can be obtained when compared with systems which simply monitor how and when a vehicle is driven.

In some embodiments, different layers of functionality can be selected to be considered when determining the driving style, and hence driver profile, for a driver. For example, one, some, or all of the parameters listed above (RPM, speed, distance, etc.) may be considered, and it may be possible for a user to select which, if any, of the parameters are used. Additional parameters may be considered, and it may be an optional feature to monitor whether or not the vehicle is driven past “hot spots” at certain times. A hot spot may be a school at opening or closing time, a public house at closing time or any other situation where a large number of people may be present at the same time, for example at the end of a football game.

Examples of a driving style can include, but are not limited to, safe, unsafe, dangerous, erratic, steady, legal, illegal, economic, uneconomic, high or low pollution producing, aware, unaware, accelerating fast, braking hard, fast, slow or any combination of the above.

Further value can be added to known systems by including information about a driver's style in combination with information on where the vehicle is driven. The additional value in relation to the style in which a vehicle is driven can be used to allow a driver to be rewarded by lowering insurance charges, or other costs that a driver must pay use their vehicle, and/or can be used as a driving teaching aid.

It may be used to improve the driving standards of a driver as it enables a driver to be rewarded and/or receive feedback on their driving style and enables them to change their driving habits so that they are more safe on the roads and/or more economical and/or produce less pollution.

In some embodiments the driver can be rewarded or penalised depending upon how safely and/or economically they drive and how much pollution they produce. Rewarding and penalising may entail attributing a high or low score, or producing a good or bad report for the driver. Other examples of rewards can include a cash prize, a voucher for spending in a store/restaurant, a holiday, a gift item, praise and/or recognition of the driver's abilities, etc. Other examples of penalties can include recognition of the bad driving by a low placing in a league table of drivers, withholding a reward mentioned above, increasing an insurance premium, etc.

The reward and penalty may be for a selection of driving characteristics or for the overall driving style. This may further encourage a driver to improve their driving habits in terms of safety for themselves and other road users, and also environmentally in terms of how much fuel they consume and the amount of harmful exhaust emissions that are generated by the engine.

If the driver drives as part of his employment duties then the method may also be of use to the driver's employers. An employer may be able to select which one of a number of drivers to use based upon their driver profiles and/or to reward employees for good driving.

The method could be useful in training for a driving test or it could actually form part of a driving test. By way of example, the driving test could form part of the standard driving test that is required for all drivers to legally drive on the public highway, or it could form part of an advanced driving test or a specialist driving test such as, for example, a driving test for the emergency services. Therefore aspects of the invention can be considered to be directed to “a method of driver training” or to “a method of improving driver safety”.

A scenario can be envisaged in which a driver has been convicted of a driving offence and the method is used as an assessment as part of the driver's rehabilitation or retraining.

A further example may be to penalise drivers who drive during the rush hour on busy roads. The penalty may encourage the driver to take public transport which will produce less pollution overall and also make the roads safer as there are less cars on the roads.

It may be possible for a user to select and build up the layers of analysis that should be applied. For example a graphical user interface may be used to set up the system and a user may electronically tick boxes next to parameters that they wish to be considered for the driver profile and/or feedback.

The feedback to the driver may be the same as the driver profile; that is the driver profile itself is fed back to the driver. The driver profile may provide sufficient information to provide useful information to the driver such that the driver can improve their driving style based upon the driver profile alone.

In some embodiments the feedback may be a report giving the driver performance ratings for various categories. The report can indicate to the driver particular areas where they need to improve in order to become a safer driver. The report can help to specifically target specific areas for an individual person where they need improvement for example, economy, awareness, etc.

The report may include one or more scores based on the style of driving as a function of the location of the car, and/or one or more scores based on the style of the driving as a function of the driving conditions experienced by the car at locations where the vehicle is driven.

The driving conditions may include one or more of: speed limits; road works; proximity to certain buildings/amenities/facilities such as schools, hospitals or town centres; accidents, temporary speed limits; special events; weather conditions; congestion levels; or any combination thereof.

A database may be accessed to provide information on the driving conditions present at locations where the vehicle is driven.

The report may indicate to a driver characteristics of their driving style where they are at fault, but where the driver was not aware that they were driving poorly/unsafely. For example, penalising a driver for driving unsafely in a “hot spot”, such as accelerating harshly outside a school at the end of the school day may cause the driver to think more carefully. If a driver was unaware that they were making such mistakes, the report may cause the driver to reassess their driving habits, and the route that they take. The penalties associated with unsafe driving may further impress the need for the driver to improve their safety when driving in an unsafe fashion at certain times and in certain places.

The report may be in a form chosen from: a web page; a computer file accessible over the internet; a printed document; and email; a display on a screen; a computer file; or any combination thereof. The report may be updated substantially in real time. The report may be produced periodically, which may be at the end of each journey, daily, weekly, monthly, quarterly, at the end of the calendar or fiscal year,

The driver profile may be used to verify a psychometric driver profile. This can be useful: it is not unknown for people to try to give the answers they think will make them look good in psychometric tests. Matching test results with actual measured driving characteristics can allow insurers to place greater confidence in their risk assessment of a driver.

In one embodiment, the driver profile and/or report/feedback that is provided to the user may be represented graphically for any, some, or all of, the parameters. For example, data may be represented as a bar chart, a line graph, a scatter graph or a pie chart for a parameter.

Data for a parameter can be recorded in a range or band of values so that it is easy for a user/driver to extract information from the data. The data may be represented in the form of a bar chart, where each bar represents a range of values (for example 0 to 30 miles per hour for the speed parameter) in a convenient way for the data to be viewed. In this way data in relation to known problem areas, for example driving faster than the national speed limit or having entries for an RPM that produces a lot of pollution, can easily be extracted.

A driver may be rewarded or penalised depending on the number of data entries within certain problematic ranges. For example in Great Britain where the highest national speed limit is 70 miles per hour, a user may be penalised for any entries in a speed range above 70 miles per hour. Similarly it may be that an RPM of greater than a threshold value may cause unacceptable emissions to be produced by the engine, and the driver may be punished accordingly if there are any entries for a range that is known as problematic. The threshold, and identified problematic ranges, that are deemed unacceptable may be different for different engines, different cars, in different countries/jurisdictions and exceeding that threshold or driving within a problematic range may cause the driver to be penalised.

In some embodiments the average value of a parameter may be taken into account when producing the feedback to determine how safely, how economically, and with how much pollution, a vehicle is driven. The average value of the parameter may be taken in conjunction with the data represented by the graph such that a computer software algorithm can determine whether the driving is considered safe and/or economical and/or with a reasonable amount of pollution.

In some embodiments a driver profile that has been determined from parameters obtained by the engine management system can be used to verify a theoretical psychometric profile associated with the driver. This provides the advantage that the theoretical psychometric profile can be compared with real, physical performance data and can be adjusted accordingly such that the psychometric profile is more accurate/up-to-date. In some embodiments a theoretical psychometric profile may not be required at all because the necessary data can be obtained from the vehicle that the driver is driving. In some embodiments the theoretical psychometric profile may be verified in real-time.

In embodiments where data is monitored/verified in real-time, this may mean that the profile is monitored/verified substantially as the driver drives, for example at regular intervals during a journey, or at the end of a journey, possibly at the end of every journey, such that a driver's most recent driving qualities are incorporated into the profile. This can help to ensure that the driver profile gives an accurate up-to-date impression of how the driver is driving.

A journey may be considered to be the route taken starting from when an engine is turned on, and ending when the engine is turned off. In other embodiments, short intervals with the engine turned off, for example when filling up with fuel, may not constitute the end of a journey. There may be a maximum amount of time that can elapse with the engine turned off without constituting the end of a journey. Alternatively, a driver/user may indicate the start and end points of a journey, for example by pressing a button in the vehicle. In some embodiments one journey may be automatically terminated, and another journey started, if a different driver starts driving the vehicle.

In some embodiments the engine management system may, directly or indirectly, transmit data from the vehicle to a remote location such that the driver profile can be determined at the remote location from the transmitted data.

All new vehicles sold in the European Community are fitted with on-board devices for monitoring the status and performance of the engine.

These were introduced in order to monitor emissions related to vehicles with a view to reducing harmful emissions. These monitors are accessed through a standard interface known as the European On Board Diagnostics Interface (EOBD). Other data is often available from the same connector and using the same protocols. There is also an American equivalent on-board diagnostics standard, identified by the abbreviation OBD.

The parameters associated with the vehicle whilst it is being driven may be obtained from an Onboard Diagnostics Interface (OBD). Diagnostics Trouble Codes (DTCs) produced by the OBD may be used to generate the driver profile.

A fault diagnostics system may generate data from sensors throughout the vehicle, for example; speed, distance, tachometer data, fuel consumption data, and electrical fault data. Sensor values outside of an acceptable range trigger a Diagnostic Trouble Code (DTC). These DTCs are generated and can be used to illuminate warning lamps or displays on the vehicle's dashboard and are also stored for download by technicians when the vehicle is serviced.

The EOBD system and/or fault diagnostics system may be linked to a wireless transmitter such that information generated by these systems can be analysed at a remote location, possibly in real-time.

In some embodiments, the information derived from the fault diagnostics system may be used to generate the driver profile. For example if a fault has been showing on a driver's dashboard (or has been indicated to the driver in another way) and he has been ignoring it, the driver may be penalised. Ignoring warning lights may be unsafe and cause damage to the vehicle, for example by continuing to drive without topping up the oil when the oil warning light is on.

The vehicle may communicate with the remote location by GSM, WI-FI, Bluetooth, SMS or by any other suitable means.

In some embodiments a transmitter may be plugged into an EOBD port that is already present in the vehicle to enable the data to be transmitted from the vehicle. In other embodiments the vehicle may have an in-built computer processor that can monitor the data produced by the engine management system and transmit the report to the driver directly in the vehicle without the use of a remote computer processor. In some embodiments a processor at a remote location may still be used to perform some, or all, of the processing before reporting to the driver in the vehicle.

A further consideration is that erratic, unsafe driving can damage roads. Therefore, encouraging people to drive in a safer, less erratic, fashion can help maintain the roads in a better condition.

In addition to the above parameters, a memory device may be associated with a seatbelt that can provide information about the forces experienced by the seatbelt. Such a memory may be called a “seatbelt memory”. Data obtained by the seatbelt memory may also be used to determine how safely a vehicle is being driven. Large forces on the seatbelt may indicate that a driver is driving erratically, and decelerating harshly, because their body is exerting forces on the seatbelt during these manoeuvres. A driver may be penalised if the seatbelt memory indicates that they are driving harshly and unsafely. Furthermore, the seatbelt memory may indicate whether or not a driver is wearing their seatbelt and may penalise a driver for not wearing their seatbelt as it is unsafe to do so.

According to a further aspect of the invention there is provided apparatus for training a driver of a vehicle, the apparatus comprising:
a vehicle positioning device for monitoring the location of a vehicle;
a device for monitoring parameters associated with the vehicle; a processor for generating a driver profile that indicates the driving style of the driver based upon the location of the vehicle and the parameters associated with the vehicle whilst it is being driven; and
means for providing feedback to the driver using the driver profile.

According to another aspect of the invention, there is provided a method of evaluating how much pollution is produced by a vehicle while it is being driven by a driver, comprising:
monitoring parameters associated with the vehicle whilst it is being driven by the driver;
generating a driver profile that indicates the driving style of the driver based upon the parameters associated with the vehicle whilst it is being driven; and
generating a pollution profile using the driver profile.

In some embodiments, the method of evaluating how much pollution is produced by a vehicle may not require the feature of monitoring the location of the vehicle. The location of the vehicle is not directly related to how much pollution is produced, and therefore this is not an essential requirement for this aspect of the invention.

In other embodiments the method may further comprise monitoring the location of the vehicle whilst it is being driven by the driver. This may be useful in areas which have a congestion charge, for example in a big city like London. In such areas, drivers of low emission producing vehicles may be rewarded, for example by a reduced or waived congestion charge.

Using driving style to generate a pollution profile can improve on the data provided by standard CO₂ emission tables, as miles per gallon (mpg) and actual fuel usage can provide more accurate information on how much pollution is really being produced.

In some embodiments the driving style/driver profile information can include data obtained by an exhaust gas sensor, for example an exhaust gas oxygen sensor or lambda sensor, such that information relating to how much raw fuel is being exhausted by the engine can be determined.

The pollution profile is generated using information about the driving style of the driver, and therefore gives a more realistic, and more accurate, indication of how much pollution is being produced. The driving style can use parameters such as engine RPM, or any of the parameters discussed above, which can provide a link to how much pollution is really being produced.

In some embodiments the pollution profile and/or CO₂ emissions can be used to calculate the actual usage of the vehicle accurately, such that a driver can be rewarded or penalised based on how much they use their vehicle.

Using the driving style to evaluate how much pollution is produced by a vehicle can provide a more detailed analysis of how much pollution is being produced, as opposed to monitoring where and when a vehicle is driven as is known from the prior art.

Computer software may be arranged to not only calculate the amount of pollution that has really been produced by the vehicle (as opposed to theoretical values generated by manufacturers in test conditions), but also to predict a typical further amount of pollution that will be produced by the vehicle in a given time-frame, for example the next month. This prediction may be calculated using historical values of how a driver has driven in the past, for example using data representing how aggressively they rev their car, etc. In this way a driver may be rewarded for driving in an economical fashion as they will have a predicted pollution production that will also be low for future journeys.

According to another aspect of the invention, there is provided a method of producing a psychometric profile of a driver, the method comprising:
monitoring the location of the vehicle whilst it is being driven by the driver;
monitoring parameters associated with the vehicle whilst it is being driven by the driver;
generating a psychometric profile of the driver based upon the location of the vehicle and the parameters associated with the vehicle whilst it is being driven.

It will be appreciated that all optional features relating to one aspect of the invention, are also optional for other aspects of the invention.

Embodiments of the invention will now be described in detail, by way of example only, and with reference to the accompanying drawings, of which:

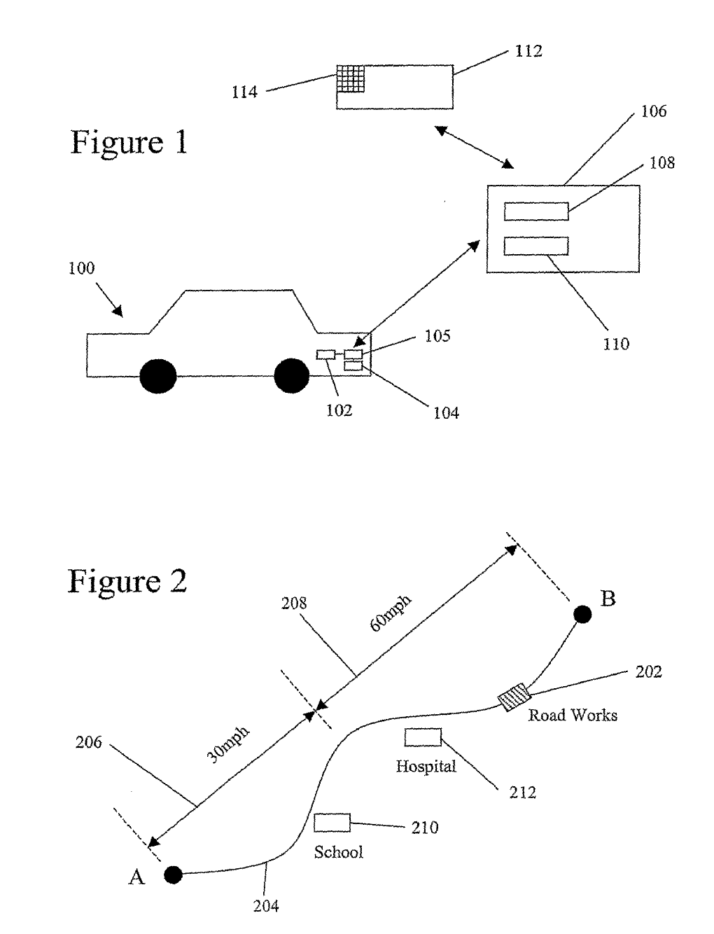

FIG. 1 shows schematically a system for training a driver according to an embodiment of the present invention;

FIG. 2 shows schematically a route taken during a journey according to an embodiment of the present invention;

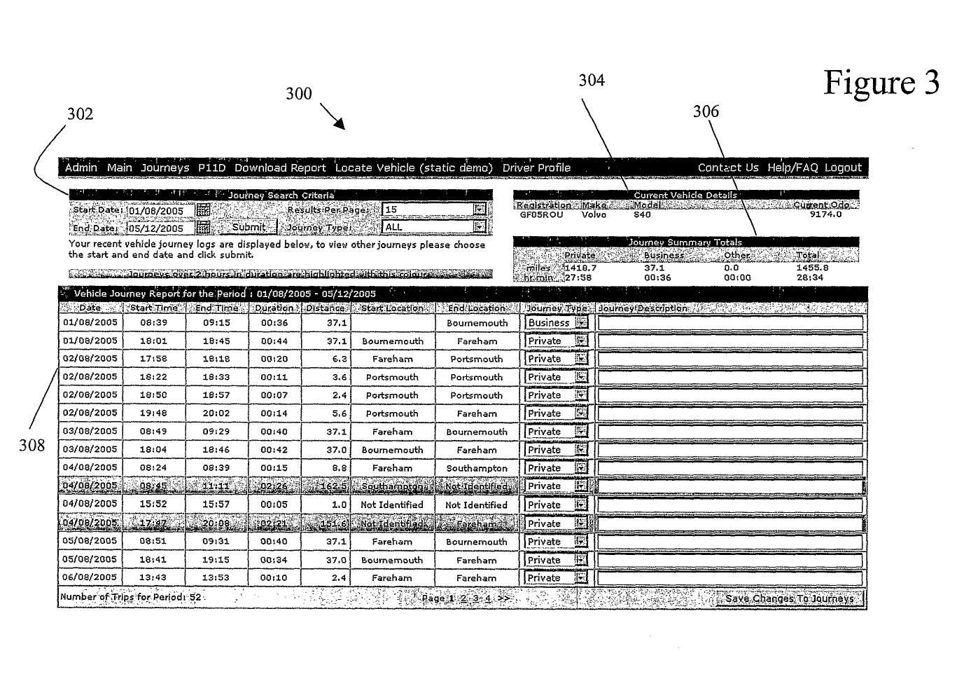

FIG. 3 shows a web page indicating journeys that have been driven according to an embodiment of the present invention;

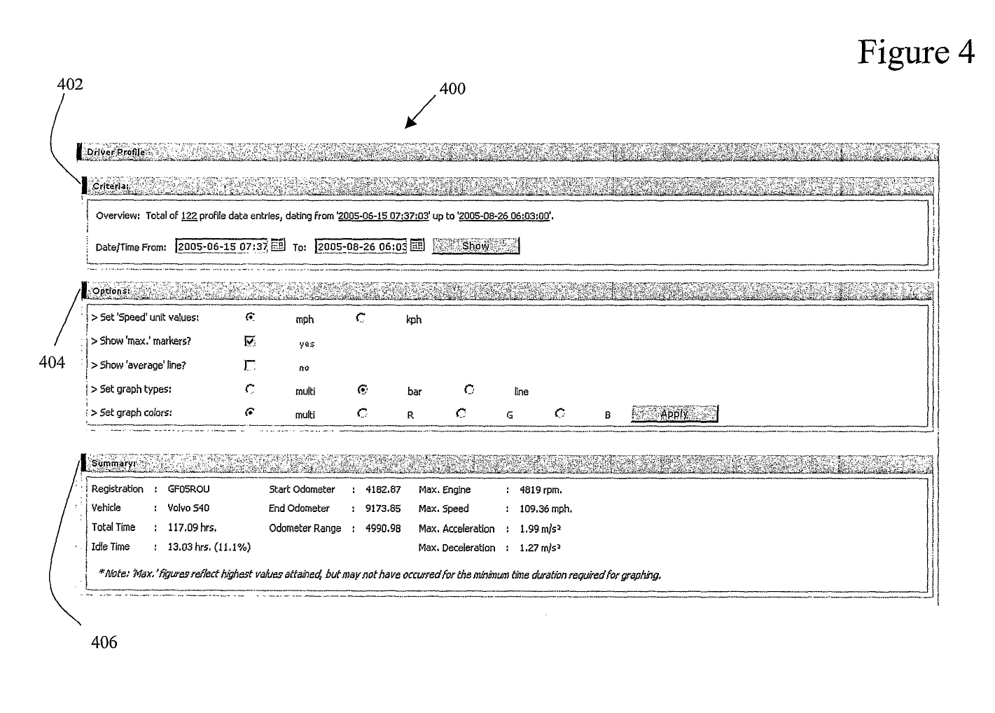

FIG. 4 shows a web page indicating part of a driver profile according to an embodiment of the present invention;

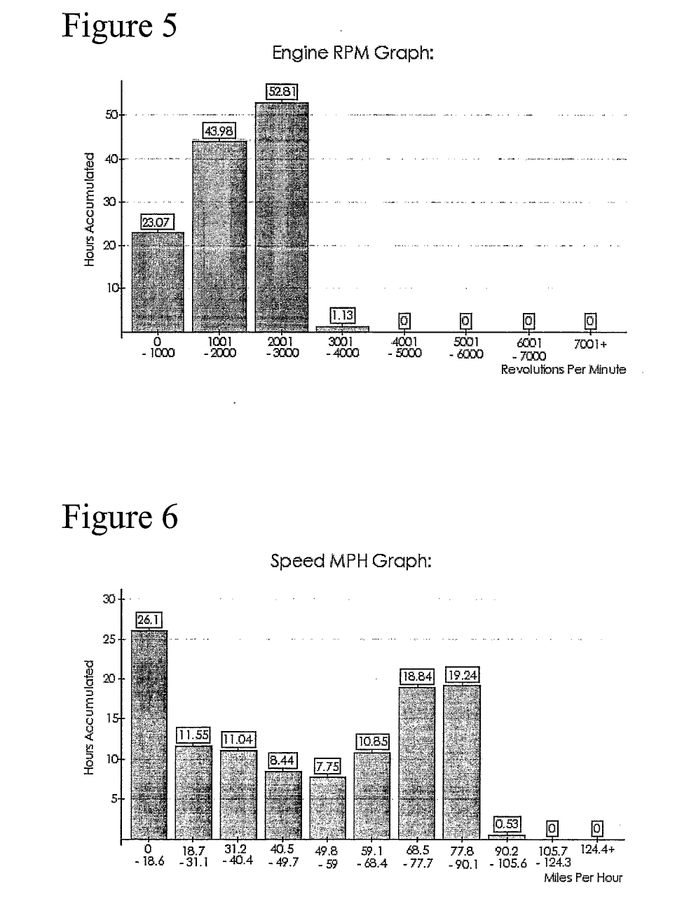

FIGS. 5 to 13 show graphical representations of data that can be used as part of a driver profile according to an embodiment of the present invention;

FIG. 14 shows a web page according to an embodiment of the invention for calculating the cost of a driver's monthly insurance charges;

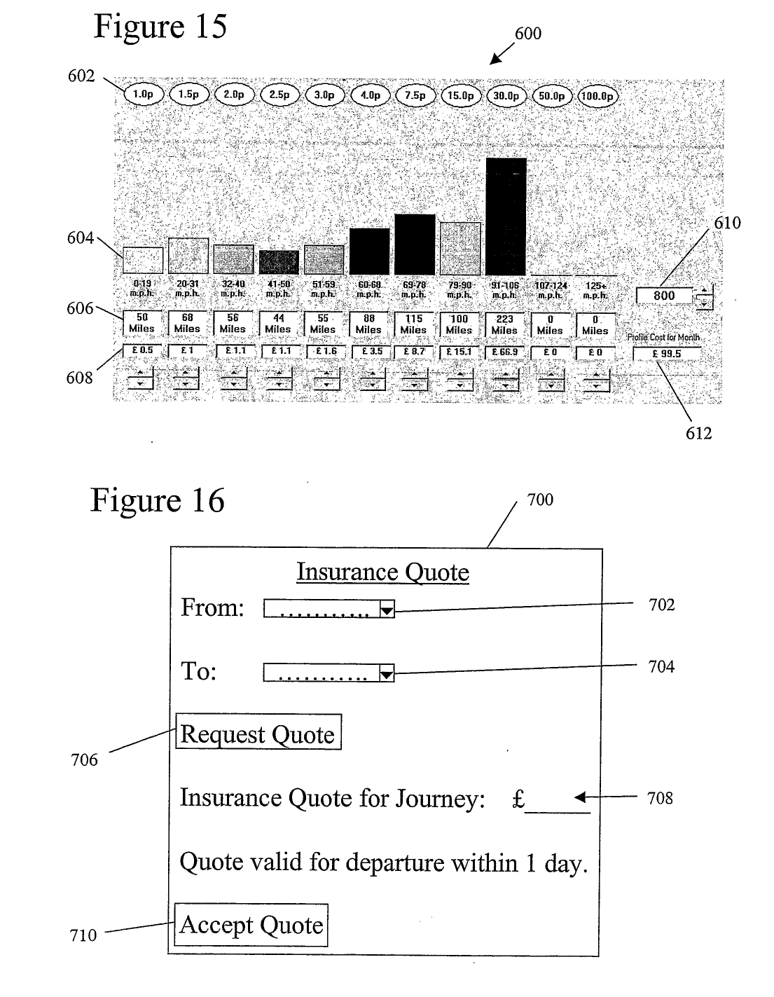

FIG. 15 shows a web page according to an embodiment of the invention for calculating the cost of a driver's monthly insurance charges;

FIG. 16 shows a web page according to an embodiment of the invention that can be used to obtain an insurance quote;

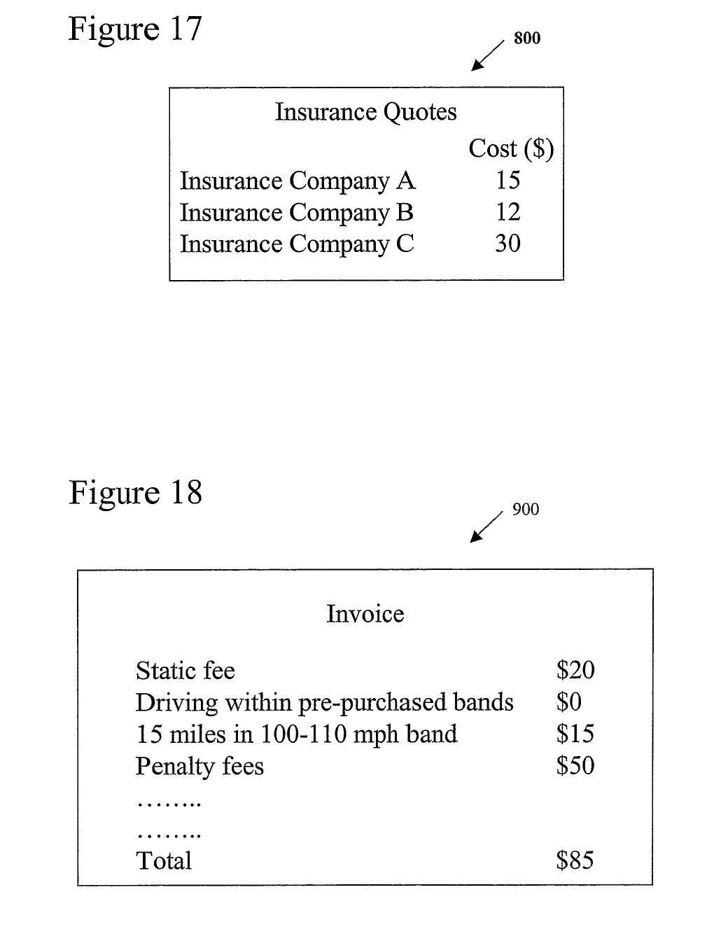

FIG. 17 shows a screen according to an embodiment of the invention that displays insurance quotes;

FIG. 18 shows an invoice according to an embodiment of the invention;

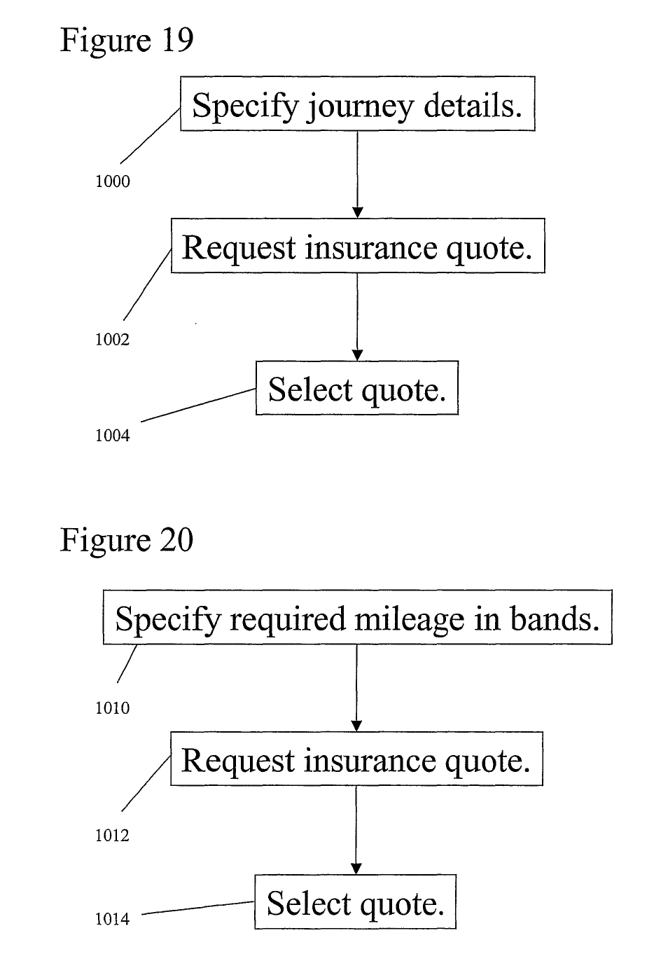

FIG. 19 shows a flow chart illustrating the steps performed by a driver to obtain insurance cover according to an embodiment of the present invention;

FIG. 20 shows a flow chart illustrating the steps performed by a driver to obtain insurance cover according to another embodiment of the present invention;

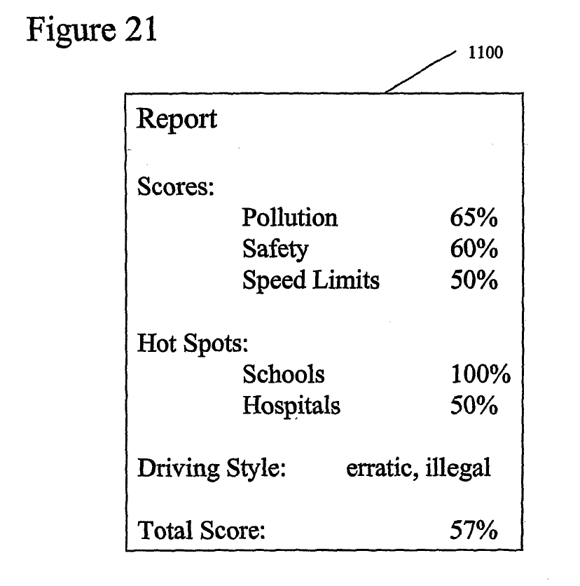

FIG. 21 shows a report according to an embodiment of the present invention;

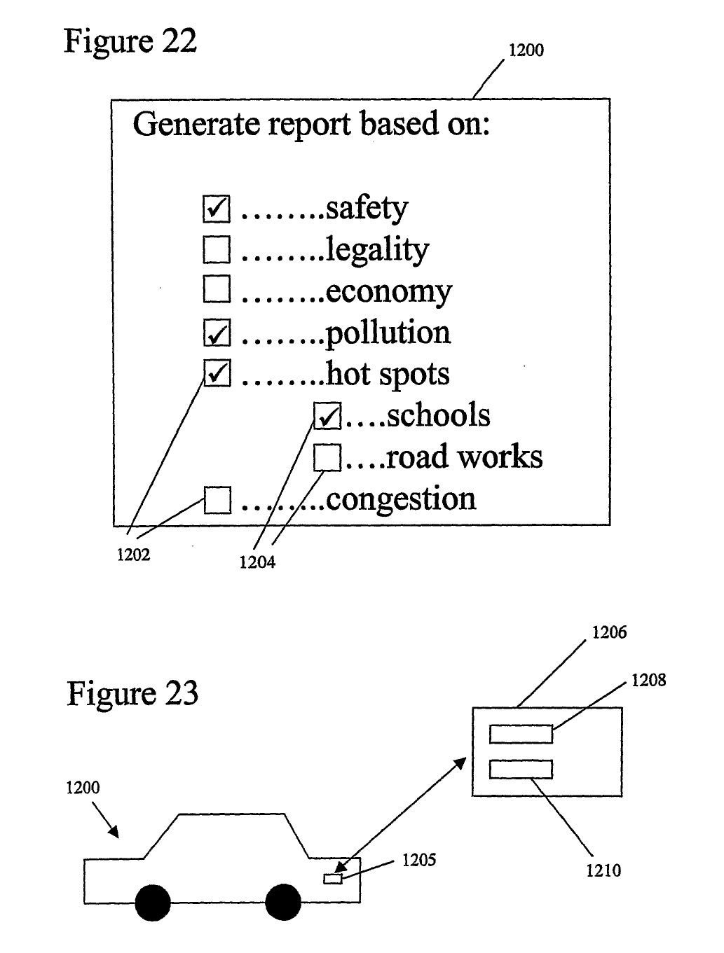

FIG. 22 shows a web page for personalizing a report according to an embodiment of the present invention;

FIG. 23 shows schematically a system for monitoring how much pollution is produced by a vehicle according to another embodiment of the present invention; and

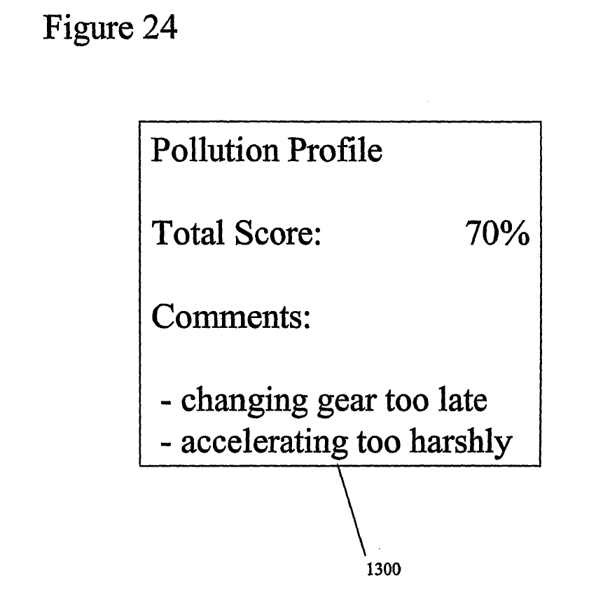

FIG. 24 shows a pollution profile according to an embodiment of the present invention.

The present invention relates to determining costs that a driver has to pay to use their vehicle, for example insurance costs, road tax, congestion charges, pollution charges. Particularly, the invention relates to pay as you drive, pay how you drive, pay how you pollute, pay how you congest, etc. related to where, when and/or in what conditions/circumstances a vehicle is driven. The conditions/circumstances may include prevailing road conditions and speed limits, congestion levels, road works, weather etc. The present invention may also relate to a method and system for training the driver of a vehicle.

The driver may be rewarded or penalised for driving well, economically, safely, within the law, in a way that minimises harmful emissions, etc. by decreasing or reducing the driver's insurance premium, road tax, toll charges, future pollution taxes, for example.

FIG. 1 shows a system for calculating the insurance costs for a driver according to an embodiment of the present invention, particularly the monthly insurance premiums payable by a driver. A car 100 is fitted with a Global Positioning System (GPS) 102 and a vehicle diagnostics system 104.

The GPS 102 is arranged to monitor the geographical location of the car 100, such that the route that the car 100 is driven can be mapped. The vehicle diagnostics system 104 is arranged to monitor physical parameters associated with the car 100, particularly associated with the engine and engine management system.

As the car 100 is driven, the vehicle diagnostics system 104 monitors parameters associated with the car 100 and this data is correlated with the data returned by the GPS 102 such that the location at which specific readings for the parameters were recorded can be determined. A transmitter 105 within the car 100 is arranged to wirelessly transmit the data retrieved by the vehicle diagnostics system and the GPS data to a remote computer 106 so that the data can be processed. In this embodiment the data is transmitted in real-time as it is recorded. The data is transmitted via GSM, although in other embodiments it may be transmitted by WI-FI, Bluetooth, SMS or by any other suitable means.

The remote computer 106 comprises a computer processor 108 and computer memory 110. The computer processor 108 performs algorithms on the data relating to the location of the car 100 and the parameters that have been monitored by the vehicle diagnostics system 104 to determine a driver profile that indicates the driving style with which the car has been driven. Examples of a driving style can include, but are not limited to, safe, unsafe, dangerous, erratic, steady, legal, illegal, economic, uneconomic, high or low pollution producing, aware, unaware, accelerating hard, braking fast, or any combination of the above.

In other embodiments the style with which a vehicle is driven may be identified by scores attributed to one, or a number of, categories. In further embodiments still, the driver style may be represented by graphical representations of data obtained from the vehicle 100.

In embodiments where a driver profile already exists in computer memory 110 for a driver, recent data relating to the location of the car 100 and the parameters that have been monitored by the vehicle diagnostics system 104 for a driver can be used to update the driver profile such that the driver profile is up-to-date.

The computer processor 108 stores the driver profile in computer memory 110, and the driver profile can then be accessed by a computer processor (which may or may not be computer processor 108) to determine whether or not the driver should be rewarded or penalised due to their recent driving style, and if so, to what extent. This can further improve the safety and quality with which a driver drives.

In other embodiments the reward for good driving may be a cash prize, a voucher for spending in a store/restaurant, a holiday, a gift item, praise and/or recognition of the driver's abilities for example, a league table of drivers may be published, etc.

The rewards may be used to encourage a driver to drive more safely and to a higher standard in the future. In this embodiment the reward/penalty is a reduction/increase in the costs that a driver must pay to use their vehicle, as discussed in more detail below.

A penalty for bad driving may be anything detrimental to the driver, for example, increasing the costs they must pay to use their vehicle (insurance, road tax etc.), recognition of the bad driving by a low placing in a league table of drivers, withholding a reward mentioned above, etc. The league table of drivers may be considered by an employer when selecting which of a number of employed drivers should be selected to drive a journey.

In this embodiment the driver profile is used to influence the insurance costs that a driver must pay to use their vehicle. Examples of costs can include insurance premiums, excess payments when making a claim from their insurance provider, static periodic charges.

If the driver profile indicates that the driver has a history of driving safely, the driver's insurance costs may be reduced.

If the driver profile indicates that the driver has historically driven in an erratic fashion, or at busy times (for example during rush hour), the driver's insurance charges may be increased.

If the driver profile indicates that the driver has driven uneconomically and/or harshly such that the engine has produced a high amount of pollution, the driver may also be penalised.

The driver profile may be considered for recent journeys that the driver has made such that the driver's most recent driving style can be used to influence whether or not the driver is rewarded or penalised. This can encourage a driver to change their driving habits as they can be rewarded by a reduction in the costs that they have to pay relatively quickly after they improve their driving style.

In some embodiments, any data relating to information that is older than a certain threshold will not be considered so that a driver can be properly rewarded for their recent driving habits. For example, any data recorded in relation to how a driver has driven more than 3 months, 6 months, 9 months, 1 year, 2 years or 3 years ago, may not be considered when generating the driver profile. An insurance company, for example, may set the time limit at when “old” data is no longer considered, in order to set how reactive it is. The shorter the time after which the recorded data is considered “old” and no longer used to generate the driver profile, the more reactive the driver profile can be considered as the driver profile reflects recent driving trends more quickly.

The driver profile may be used to influence an invoice that is sent out periodically to a driver, and may or may not include static charges. Charges can be determined dynamically dependent on how well, how often, and where a driver uses their vehicle.

In some embodiments the remote computer 106 may access a further computer memory 112 to determine characteristics of the route that the driver has taken. Characteristics of the route may be stored centrally on a single computer memory in order to avoid having to update a number of different computer memories each time a dynamic characteristic of the route changes, for example road works are started or finished.

The memory 112 may include a database 114 that provides physical features that are associated with certain roads, portions of roads or geographical coordinates. For example, the location of prevailing road speed conditions and speed limits that are in force on roads, congestion levels, buildings/amenities that require special attention (for example schools, hospitals, etc.), road works, weather conditions, accidents, closed roads, temporary speed limits, special events, etc. may be stored in database 114.

In the UK, data identifying the speed limits on roads is published by the Government, but held separately by each of the regional Department for

Environment, Food and Rural Affairs (DEFRA) agencies, or highways. authorities.

In other embodiments, the physical features associated with certain roads may be stored in the computer memory 110 of remote computer 106, or in an in-built memory within the car 100, and a separate memory 112 is therefore not necessary.

In other embodiments, the data may be transmitted to the remote computer 106 periodically, for example at the end of each journey, daily, weekly, monthly, quarterly, at the end of the calendar year, at the end of the fiscal year, at the end of a billing period, etc. to enable the driver profile to be updated/archived.

In further embodiments still, the data may be transmitted when the car 100 is in a specific location, for example near a receiver arranged to receive the information.

In some embodiments, the data may be stored in local memory within the car 100, and all subsequent processing of the data is performed within the car 100.

The computer processor 108 can store the driver profile in computer memory 110. In some embodiments, the driver can then access computer memory 110 using the Internet (or any other means) to inspect the driver profile to obtain feedback on how they have driven the car 100. The feedback can be used as a training aid to improve the quality of a driver's driving skills, and also as a safety device by highlighting to a driver characteristics of their driving where they are unsafe, uneconomical or produce a lot of pollution.

FIG. 2 shows schematically an example of a route 204 that has been generated from the GPS co-ordinates returned from a car whilst being driven from A to B according to an embodiment of the present invention. The GPS co-ordinates have been used in conjunction with information stored in computer memory (for example database 114 in FIG. 1) to determine characteristics of the route 204. It will be appreciated that the route need not necessarily be generated graphically, and that it may be encoded in computer memory.

The characteristics of the determined route show that two different speed limits are in force between A and B. The speed limit is 30 mph in region 206, and the speed limit is 60 mph in region 208. Data returned from the vehicle diagnostics system can be analysed in combination with the information about the known speed limits between A and B to determine whether or not the driver is exceeding the speed limit at any time during the journey.

The information stored in computer memory also indicates that the route 204 passes a school 210 and a hospital 212. Schools, hospitals and the like may be considered as “hot-spots” as they require particular attention by the driver when passing them. The driving style of the driver can be determined in the vicinity of these buildings to determine how mindful the driver was as they were passing these buildings. For example, if the driver slowed down as they passed these buildings, and did not accelerate or decelerate sharply, this may indicate that the driver was aware of his surroundings and was driving accordingly. A driver may be rewarded for such driving.

In some embodiments the time of day may be taken into account when considering how safely a driver passes a hot spot. A driver may not be expected to slow down and drive particularly cautiously past a school if the school is closed, for example if it is during school holidays or after the end of the school day.

Computer memory may also be capable of indicating temporary/dynamic features that are present on a route 204, for example road works 202. In this example road works 202 are present in between the hospital 212 and B, and there is a temporary speed limit of 30mph in the vicinity of the road works 202. This temporary speed limit may override the national speed limit that is otherwise in force on the road. Again, the care and speed with which a driver passes road works 202 can be considered when analysing how well a driver is driving.

FIG. 3 shows details relating to the journeys that a driver has taken in the form of a web page 300 in accordance with an embodiment of the present invention. The web page is an example of the data that can be passed to a third party (for example an insurance company) in order to determine whether or not the driver should be rewarded or penalised by increasing or decreasing the costs that a driver must pay to use their vehicle. Also, in some embodiments the web page may be part of the feedback that is available to the driver as part of the driver profile.

The web page has a journey search criteria section 302 that enables a user to select a date range of journeys to be displayed. It is also possible to select the journey type to be searched (for example business, private, or other), and how many results are displayed per page.

The current vehicle details are indicated in section 304, and a summary of the total time and distance for business, private and other purposes is illustrated in section 306.

Section 308 shows a vehicle journey report for the specified period. Each row represents a journey, and includes the date, start time, end time, duration, distance, start location, end location, journey type and an optional journey description. The values for the date, start and end time, duration and distance are filled in automatically by the data returned from the vehicle diagnostics system and GPS within the car. The start and end locations are a guide only, and may be obtained from the subscriber trunk dialling (STD) code of the nearest or strongest signal emitted from a telecommunications mobile cell mast. In borderline areas, the location may register to a neighbouring STD code. Information relating to the journey type and the optional journey description may be inserted manually by a user.

FIG. 4 shows a graphical user interface on a web page 400 that displays search criteria 402, options 404 and a summary 406 of a driver profile according to an embodiment of the present invention. The web page 400 may be also be available to a third party (for example an insurance company) in order that the third party can select parameters to consider when determining whether or not, and to what extent, a driver should be rewarded or penalised.

The search criteria box 402 can enable a user to select a date and a time range of journeys to be considered for determining a driver profile. This can enable a driver's profile to be determined for a specified selection of journeys and can be tailored for individual needs. For example, a reactive insurance company may only consider data relating to the last 3 months journeys when calculating an insurance premium for a driver. Whereas a less reactive insurance company may also consider data dating further back, for example over the last year. An insurance company may review any information in relation to the driver's driving profile history when calculating an insurance premium.

The selection of journeys may be just one journey. This can allow any changes in the driver's profile over time to be easily monitored. In some embodiments, search criteria may not be available to the user, and a default time range is automatically selected for the user by computer software.

A third party (or any other user) can set a number of options by selecting or deselecting icons in the options box 404. Examples of options that can be set are: the units that are used to measure speed; showing maximum markers for parameters in the profile (for example the maximum speed); showing an average line in a driver profile graph; setting the type of graph; and setting the colour of the graphs. In other embodiments, some, all, or none, of the above options may be available.

The summary section 406 of the web page 400 indicates a number of readings associated with the car. Some of the readings are static and will not change over time, for example, registration and vehicle. Other readings are associated with the time range selected in the search criteria box 402 and are dynamic, for example, total time, max. speed etc. In some embodiments the “max.” figures reflect the highest values attained, but may not have occurred for the minimum time duration required for graphing.

FIGS. 5 to 13 show examples of parameters that have been recorded. One, some, or all, of the parameters may form part of the driver profile.

Revolutions Per Minute

Data relating to engine revolutions per minute (RPM) is shown in FIG. 5. The engine RPM can be monitored to determine how aggressively a driver is driving, and how much pollution the vehicle is generating. High revolutions per minute will generate more C0₂ and other pollutants in the exhaust fumes. A driver may be penalised for driving with high revolutions per minute. High values for RPM may also indicate that the driver is accelerating quickly as they are revving the engine harshly before changing up a gear, and this may be deemed unsafe or uneconomical.

Speed

The speed at which a vehicle is driven is shown in FIG. 6, and can also indicate how safely the vehicle is driven. This may be particularly useful when used with a global positioning system (GPS) which can determine where geographically a vehicle is being driven, and at what speed. For example the speed at which a driver is driving can be compared with the national speed limit that is in force on that road. Exceeding the speed limit may cause the driver to be penalised.

Furthermore, the speed at which a vehicle is being driven can be compared with certain buildings/amenities/facilities, possibly at certain times, to determine whether or not the vehicle is being driven safely given outside influences. For example, a driver may be penalised for driving quickly outside a school at the end of the school day. In such an example the time at which the vehicle is driven past the school can determine how safely the vehicle is being driven in specific circumstances.

Distance

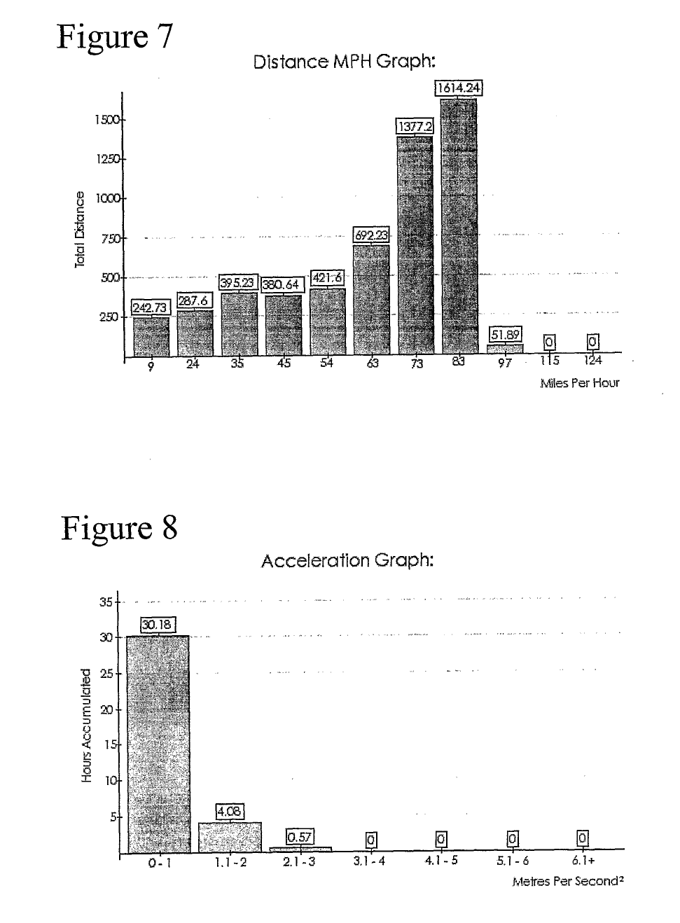

FIG. 7 shows the total distances that a vehicle has been driven in certain speed ranges. Statistically it is more likely that a driver will have an accident if they drive long distances, and more likely still to have an accident if they drive long distances at certain speeds or in higher risk bands. Therefore, a driver may be rewarded for not driving long distances. They may also be penalised if they drive long distances in a given time frame, or at certain speeds. For example a driver may be penalised for driving a total of 12,000 miles per year, or perhaps 15,000 miles per year for a person who earns their living from their, car such as a company representative, as statistically this makes them more likely to have an accident. Other threshold values of distance driven may be considered for individual speed ranges. For example, as an indication of the amount of motorway driving that a driver does.

Encouraging a driver to drive fewer miles can help increase the safety of that driver, and the safety on the roads as a whole.

Acceleration

The acceleration of a vehicle is illustrated in FIG. 8 and can be directly linked to the amount of pollution that the vehicle produces. A fast acceleration, typically with correspondingly high RPM, will use the engine inefficiently and can cause greater pollutants to be present in the exhaust of the vehicle as there will be a lot of un-burnt fuel. A user may be penalised for the amount of emissions that their vehicle actually produces and how efficiently their driving style causes fuel to be burnt by the engine, rather than the theoretical values produced by a manufacturer in test conditions that are measured for a vehicle being driven in a certain way. Furthermore, a fast acceleration can indicate aggressive, uneconomical, and unsafe, driving as the driver will have less time to react to changing circumstances, and a driver may also be penalised for this.

Deceleration

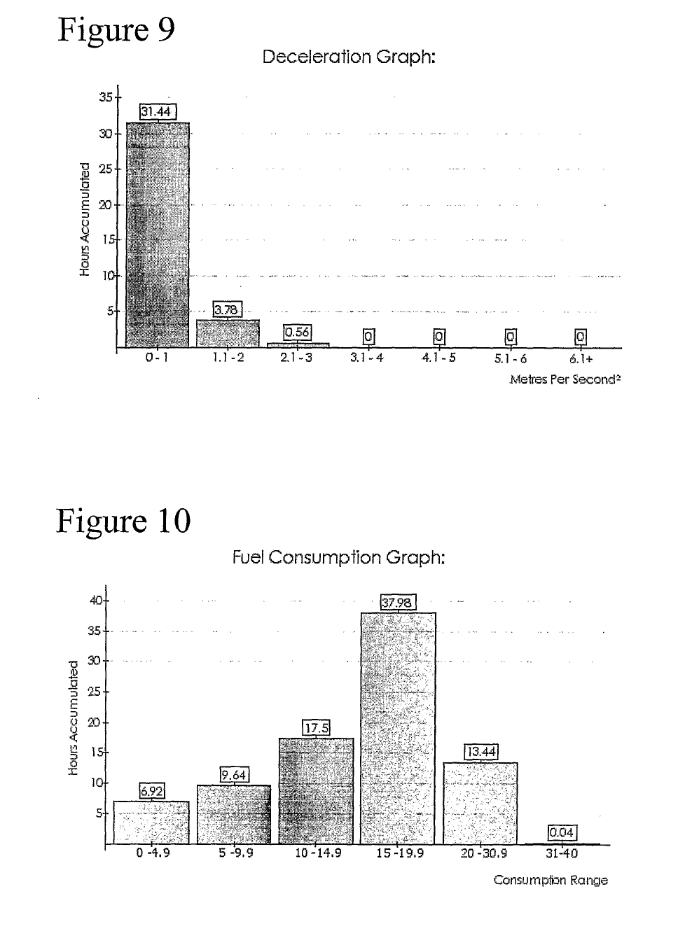

The rate at which a driver decelerates can have similar repercussions as the rate at which a driver accelerates. An example graph showing the deceleration that a vehicle experiences is shown as FIG. 9. Rapid deceleration can indicate an erratic, unsafe, driver who may be more likely to have an accident than a driver with a lower deceleration. A low deceleration can indicate that a driver is thinking ahead, driving considerately, and giving himself more time to react to an incident in front of them.

Fuel Consumption

The fuel consumption of a vehicle's engine can indicate how smoothly a vehicle is being driven and can provide a direct link to how economically a vehicle is being driven. A low fuel consumption can indicate that the vehicle is being driven smoothly and that the driver is not accelerating or decelerating harshly. Low fuel consumption can therefore be an indicator that the vehicle is being driven considerately and safely. Furthermore, low fuel consumption can cause a driver to be rewarded because they are driving their, vehicle in a more economical manner.

Throttle Position

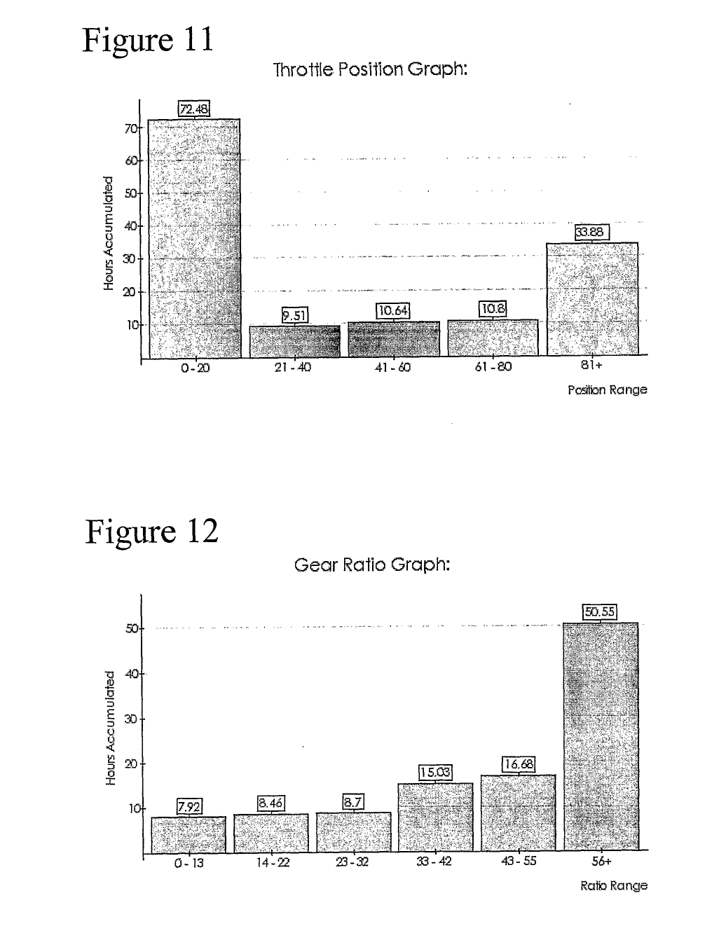

The position of the throttle is shown in FIG. 11, and may be monitored by the engine management system. The position of the throttle can be a direct link to the aggressiveness with which a driver is driving a vehicle. If a driver uses their vehicle with the throttle mainly in a fully depressed position, as opposed to accelerating steadily and increasing the pressure on the throttle steadily, this can indicate that the driver is driving aggressively and therefore unsafely. In some embodiments, even if the actual value of the acceleration and the speed of the vehicle is not very high the fact that the throttle is depressed fully can indicate that the driver is aggressive in their driving style, and therefore can be penalised accordingly. A driver that depresses the throttle fully can indicate that the driver has an aggressive mindset, and may be driving unsafely. Similar measurements may be taken of the position of the brake and clutch pedals in order to better define the driving style with which a vehicle is being driven.

Gear Ratio

FIG. 12 shows the time spent driving in gears with certain gear ratios. This parameter can give a general indication of the type of driving being performed. For example, all low gears could indicate a lot of town driving, and all high gears could indicate a lot of motorway driving. Furthermore, the gear ratio parameter can identify drivers who miss out gears or who slip gear a lot. Drivers who use the wrong gear and cause the engine to run inefficiently, for example changing from first gear to fourth gear through the gate, or starting off with a heavy load in second gear, may be penalised accordingly.

The ratio range indicated on the horizontal axis of the graph is the ratio of the engine revolution speed to the speed of the vehicle. The gear ratio is revolutions per minute divided by miles per hour (RPM/MPH).

Idle Ratio

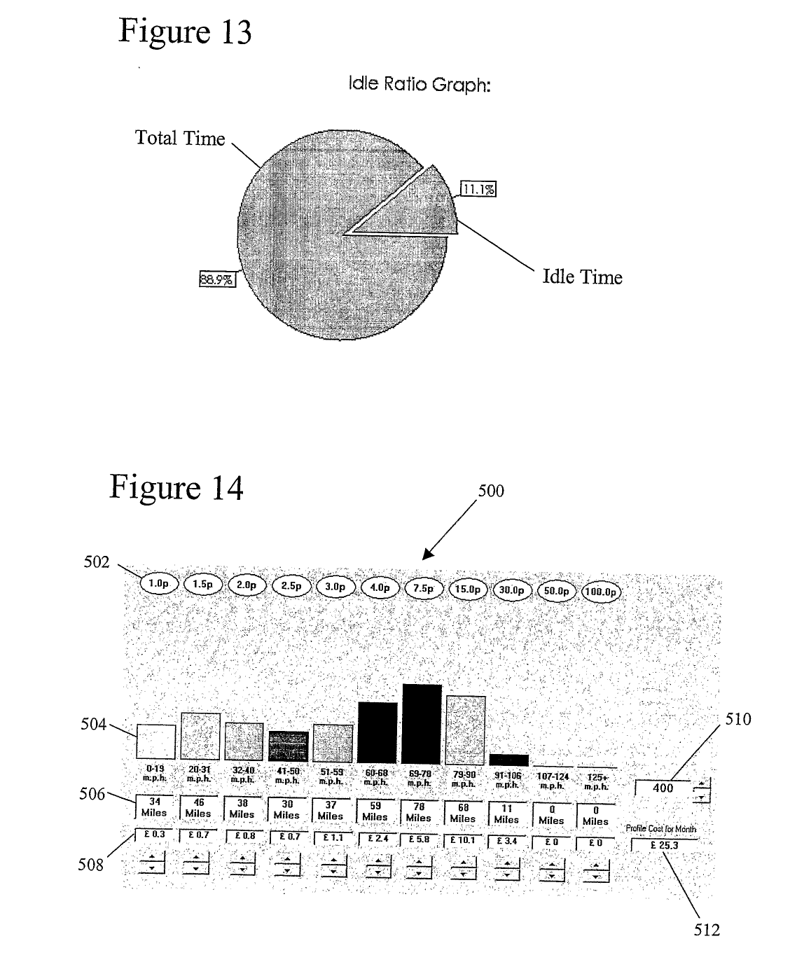

The idle ratio is shown as FIG. 13 as a pie chart. The idle ratio indicates the proportion of a driver's journey(s) that the vehicle is stationary to that at which the vehicle is moving. If a driver is stationary for a large proportion their time in their vehicle this can indicate that they have chosen a busy route that has a lot of traffic. A driver may be penalised for having a large proportion of idle time as they are producing emissions without actually going anywhere or gaining any benefit from being in their car. Performing a journey with a lot of idle/stationary time creates more pollution than performing a journey with only a little idle/stationary time.

Also, the idle ratio can indicate that a driver is sitting in their vehicle with the engine running for long periods of time. This may be to waste time, for example while waiting for something/someone, or to keep warm when they are cold. A driver may be penalised for using their car in this way as it is inefficient and produces unnecessary emissions and pollution.

It will be appreciated that the graphs shown in FIGS. 5 to 13 are illustrative only, and can take any known graphical form, for example line, bar, pie-chart, scatter graph, etc. In some embodiments the data may not be graphically displayed at all, and the data can be simply manipulated by computer software to generate feedback that can be provided to the driver. An example of feedback in the form of a report is discussed below.

FIG. 14 shows a web page 500 that has been used to calculate the cost of a driver's monthly insurance charges. This may be in addition to a static monthly charge.

Web page 500 indicates the distance that a driver has driven in specified speed bands. The distances driven per speed band in the month are illustrated as bars 504 and a numerical value for the distance is illustrated in boxes 506. The cost of a mile 502 in each of the speed bands is illustrated at the top of the web page 500. It can be seen that the cost per mile increases as the speed increases. This is because the driver is more likely to have an accident, and therefore more likely to make a claim under the insurance policy if they are driving quickly. Making a claim under the insurance policy costs the insurance company money, and it is an aim of the insurance company to minimise the number of claims that are made under it's policies, or at least to maximise the return for any claims that are made.

The cost for all miles driven in each band is indicated in boxes 508, and the total cost for driving in all miles during the month is indicated in box 512.

In this embodiment, the driver has driven 400 miles in a month as indicated in box 510 and has recorded miles in 9 of the 11 speed bands as defined by the insurance company. Apart from a few miles in the 91-106 m.p.h. zone, the driver has not driven an excessive number of miles in total, and the majority of the miles are below 70 m.p.h.; which is the highest national speed limit in force in the UK. The driver's monthly invoice will be £25.30 above his static monthly insurance bill.

The static monthly charge may be to cover fire and theft whilst the vehicle is not in use. In some embodiments the charge in relation to fire and theft may be calculated based upon where and when a vehicle is not being driven. For example, if the vehicle is left in a “safe” neighbourhood, that is one with a low crime rate/vehicle crime rate, the costs in relation to fire and theft may be reduced. Also, the charges in relation to fire and theft may be reduced if the vehicle is left within a garage, a secure car park etc., as opposed to on the street where it may be more accessible to thieves.

FIG. 15 shows a web page 600 that is similar to the web page 500 shown in FIG. 14, and similar reference numbers in the 600 series have been used to indicate features that are similar to those of FIG. 14.

In this example, the driver has driven 800 miles as indicated in box 610, and has driven 223 miles in the speed band for 91-106 m.p.h. Driving a large number of miles in total, and also a large number of miles at high speeds has contributed to a high monthly invoice of £99.50.

The examples of FIGS. 14 and 15 show how driver behaviour can affect the risk taken by an insurance company when deciding whether or not to insure a driver, and how much the charges should be. This can allow the insurance company to have better control of where and how they are taking risks with individuals, people in a specific age range, male and female drivers, or any other category of driver, or their entire customer base.

The examples shown in FIGS. 14 and 15 illustrate a consideration of the number of miles driven in speed bands. It will be appreciated that in other embodiments the speed may be recorded by the amount of time that a vehicle is driven at that speed. In other embodiments any of the parameters discussed above may be used to illustrate driver behaviour. In further embodiments still, a matrix of a number of factors effecting the risk can be considered when determining the fee per mile that should be charged for a specific driver. An example of further factors that can be considered are the age of the driver, car types, time of day, harsh breaking, fast acceleration, geo-coded data on road speed maps, hot spots, or any of the factors/circumstances discussed above.

In other embodiments, a driver may be able to pre-purchase insurance by using a web page as shown in FIGS. 14 and 15. A driver may be able to select and pre-purchase a number of miles in certain speed bands, in a way that is similar to purchasing per-paid airtime for mobile telephones, commonly known as “pay-as-you-go”.

Such a system for vehicle insurance involves an insurance company calculating a fee per mile for a specific driver, displaying this to the driver, for example via a web page similar to that shown in FIGS. 14 and 15. The driver can then select and pre-purchase the desired number of miles in each band and/or a total number of miles. In some embodiments a driver may be penalised with excess mileage charges if he drives more than the mileage that he has pre-purchased in certain bands, and/or more than a total mileage that he has pre-purchased.

In some embodiments, a driver may pre-purchase credit for insured mileage independent of which speed bands the vehicle is driven in—it is the total cost of the mileage that matters rather than the break down of the mileage in each band. When the vehicle is driven the cost of the pre-purchased miles may be reduced by the cost per mile depending on which speed bands the driver actually drives in. The cost per mile can be set according to the insurance company's assessment of the driver's profile, and the insurance company's attitude to risk. Both of these factors can vary over time, and this can result in the cost per mile for a driver being different when a user decides to buy pre-purchased miles. In some embodiments the fee per mile may be fixed for a given journey, or for a given time frame (for example until a pre-purchased amount of credit is used up). Updated fees per mile may be indicated to a driver when they change.

The driver may be able to top-up his pre-purchased miles at any suitable time, for example by logging onto a website over the internet, going into a shop and buying more credit, buying a top-up card to transfer credit onto their account, or by any other means. In some embodiments a driver may be warned that his credit is low, for example when it falls below a threshold value, or when it reaches zero. The driver may be warned/notified by any means, for example by receiving a telephone call or SMS text message, by flashing a warning up on a driver's satellite navigation system, by presenting the driver with a message next tine they log into their account, etc.

In some embodiments the driver profile can be available to an insurance company in real time such that the insurance company can provide quotes for providing insurance for a specified journey. The insurance quote can be based upon how the driver has driven by using information from the driver profile. A good, safe driver may be rewarded with a lower insurance quote than a driver who has a history of driving badly.

The price per mile offered by the insurance company can be determined by the insurance company based upon the driver's profile, the age of the driver, the type of car, the location of the journey, etc. embodiments of the invention may benefit young drivers where insurance costs can be high for young/newly qualified driver.

A driver may have more than one car on his drive, and the insurance quote for a specific journey may differ depending on which car he uses and may influence which car he selects for the journey. Alternatively a vehicle fleet manager may be able to select which of his fleet to use based upon the insurance cost for each driver/vehicle combination.

FIG. 16 shows an example of a web page 700 according to an embodiment of the invention that can be used to obtain an insurance quote for a specific journey. The web page includes two drop-down boxes 702, 704 that a user can use to specify the start and end destinations for the journey. The destinations may be identified by town, street address, post code/zip code, or any other means.

Once the user has specified his desired start and end destinations in boxes 702 and 704, he clicks the “Request Quote” button 706. This transmits a request for a quote to the insurance company. The insurance company then retrieves the archived driver profile associated with the driver making the request, and determines a quote for the driver based on how the driver has driven in the past.

The insurance quote for the journey will be indicated at 708, and the length of time for which the quote is valid may also be indicated. In this embodiment the quote is valid for departure within 1 day from when it was requested, but in other embodiments the quote may be valid for any period specified by the insurance company. In some embodiments, the insurance company may be unable/unwilling to insure the driver as the insurance company determines that there is too much risk associated with the driver. The insurance company may be unwilling to insure a driver for the journey specified if there is a specific risk identified for the combination of the driver and the journey—the specific risk may be determined from the driver profile and/or characteristics of the journey specified. In other embodiments the insurance company may be unwilling to insure the driver for any journey, as their assessment of the driver's profile determines that there is too much risk associated with the driver.

Once the user is happy with the quote they can click on the “Accept Quote” button 710. The web page may then display a payment screen, or in other embodiments a user has already logged into the system such that the system already knows the payment details associated with the user such that the insurance company can take payment as soon as the user clicks the “Accept Quote” button 710.

In some embodiments the web page may provide a user with further options when requesting an insurance quote. For example, a user may be able to obtain a quote for a return journey, for multiple journeys, or may be able to pre-pay for insurance for the specified journey for travel within certain speed bands, as discussed in relation to FIGS. 14 and 15.

In some embodiments a user may be able to enter their journey requirements for which they require an insurance cost estimate, and obtain cost estimates from a number of insurance companies in real time, or substantially in real time. The driver can then accept the insurance quote that is best for him.

An example of a screen 800 according to an embodiment of the invention that may be displayed to a user after requesting quotes from multiple insurance companies is shown as FIG. 17. In this example a user has requested an insurance quote and has received four quotes from different insurance companies. In some embodiments the user may select from which specific insurance companies he would like a quote. In other embodiments an insurance broker may be used as an intermediary between the driver and the insurance companies. The broker may determine which insurance companies are contacted for quotes, and may select the insurance companies with which it has business affiliations, or any other links.

The user can then accept or reject the insurance quotes by any known means, for example, by pressing/clicking a button associated with the desired insurance company, by using a touch sensitive screen to select the desired insurance company, etc. In some embodiments the driver can accept or reject insurance quotes from within their vehicle.

This embodiment of the invention can allow multiple insurers to evaluate how much risk they want to take for a given driver, and optionally how much risk they want to take for a given speed or price band. This can allow a specialist insurer to take higher risks and charge higher costs for these risks. This embodiment of the invention can also allow an insurance quote to dynamically change how much risk they would like to take based upon certain factors, for example how profitable the insurance company is, how much work the insurance company has, etc.

An insurance company may be able to accurately calculate and control the profit per mile.

It will be appreciated that the web pages discussed above may be accessible from a PC connected over the internet, and in some embodiments may be accessible within vehicle. For example, a driver/user may be able to manage their insurance quotes from within their vehicle by interacting with the insurance company, either directly, or indirectly via a broker. The driver may use a satellite navigation screen that is already present in the vehicle, or alternatively may use a mobile phone, a personal digital assistant (PDA), a BlackBerry, a lap-top or any other suitable means.

FIG. 18 shows a monthly invoice 900 generated for a driver of a vehicle according to an embodiment of the invention. The driver of the vehicle has pre-purchased mileage in a number of bands as discussed above, and the cost of these pre-purchased miles may not show up on this invoice as they are purchased in addition to the periodic invoice. In other embodiments the cost of the pre-purchased mileage may show up on the monthly invoice.

In this embodiment a static fee is associated with the monthly invoice. This may cover, or be in addition to, a static charge to cover the vehicle for fire and theft whilst it is stationary.

The invoice 900 indicates that the driver has also driven 15 miles in the 100-110 m.p.h. band, for which they have not pre-purchased any miles. The driver is therefore charged the cost for driving 15 miles in the 100-110 m.p.h. In some embodiments the charge incurred by driving a number of miles in excess of the number of pre-purchased miles in a band, may be higher than the cost associated with pre-purchasing the same number of miles. This may encourage a driver to pre-purchase mileage.

In some embodiments, driving in excess of the number of miles that have been pre-purchased for a band may have a negative effect on the rating of the driver in the driver profile. That is a driver may be penalised for exceeding their pre-purchased mileage, for example by increasing subsequent insurance premiums by increasing the static fee and/or by increasing the cost per mile within all, or some, bands and/or by any other means.

In some embodiments it may not be possible to pre-purchase any miles that are greater than the highest national speed limit that is in force for that country/jurisdiction.

The invoice 900 of FIG. 18 also indicates that $50 worth of penalty fares have been incurred. Penalties may be associated with driving miles in excess of the pre-purchased amount, exceeding a speed limit, driving badly past a hot-spot or any other deficiency in driving ability discussed herein.

Embodiments of the invention allow a good driver to pay lower driving charges than a bad driver. The charges can include, but are not limited to, insurance premiums, monthly insurance charges, per-mile insurance charges, road tax, congestion charge, pollution charges/taxes etc.

FIG. 19 shows a flow chart illustrating the steps performed by a driver to obtain insurance cover according to an embodiment of the present invention.

At step 1000, a user specifies the journey details for which they require insurance cover. The user may be the driver. The journey details may indicate the start and end destination in terms of town/city names, postal addresses, postcodes, zip codes, grid references, coordinates or any other means.

The user may specify the details of the journey that he is about to make by interacting with a graphical user interface on his computer, for example via the internet, by using his mobile phone, personal digital assistant, BlackBerry etc. or an in-vehicle display, for example a satellite navigation screen.

At step 1002, the user requests an insurance quote, and in some embodiments the request may be made shortly before the driver intends to make the journey. For example, the driver may get into his car just before starting a journey, and then specify the details of the journey that he is about to make by any of the means discussed above.

Requesting the insurance quote may return one or more insurance quotes from one or more insurance companies that satisfy the user's requirements. One or more of the insurance quotes may have restrictions associated with them. Examples of restrictions can include being valid for a limited period, only valid for travelling at a certain time of day, only valid for driving within certain bands, which may be bands in relation to speed or any of the other parameters discussed above.

At step 1004 the user then selects a quote from the returned insurance quote such that he can make the journey specified.

FIG. 20 shows a flow chart illustrating the steps performed by a driver to obtain insurance cover according to an embodiment of the present invention.

In this embodiment the user specifies which speed bands he requires a quote for at step 1010. In other embodiments the user can pre-purchase mileage in a band relating to any other parameter. The user indicates how many miles in each band he would like a quote for.

At step 1012 the user requests a quote in the same way as discussed in relation to step 1002 in FIG. 19. At step 1014 the user pre-purchases a number of miles in certain bands as discussed above.

FIG. 21 shows a report 1100 according to an embodiment of the present invention that can be used to provide feedback to a driver about their driving style. The report 1100 is fed back to the driver and is generated using a driver profile as discussed above. The report 1100 includes a number of scores for particular categories and scenarios, an indication of the driving style of the driver, and a total score at the bottom of the report 1100. A driver may be further rewarded or penalised for particularly high or low scores in any of the individual categories, and/or a high or low total score.

The scores can be calculated by a computer algorithm that uses one, some, or all, of the parameters as discussed in relation to FIGS. 5 to 13. For example high values for the engine RPM may contribute to an erratic driving style and in turn a low score for safety, and the data in relation to speed may provide an indication that some speed limits have been broken thereby contributing to a driving style of illegal.

It will be appreciated that any of the parameters discussed above can contribute to the driving style, and that FIG. 21 is an example of one of a great many ways that the data may be fed back to the driver. Indeed, in one embodiment, the information shown in any of FIGS. 3 to 13 that form part of the driver profile may be fed back as a report to the driver as they are, and no further computer algorithm is required to translate the driver profile into the report. The driver profile is the report.

It will be appreciated that the report for any of the embodiments of the invention may take the form of an audio report produced by a speaker; a visual display on an electronic screen, for example an in-built screen in the vehicle, the driver's mobile phone, BlackBerry, PDA, lap-top computer etc.; a web page; a computer file accessible over the internet; a printed document, which may be posted to the driver; an email; a computer file; any combination of the above; or any other means.

FIG. 22 shows a web page according to an embodiment of the present invention that can be used to select which of a number of characteristics are used when generating a driver profile/report to feedback to a driver. A user therefore has the option of deciding which of the characteristics are important in a given scenario and tailoring the report to those characteristics.

In the example of FIG. 22, there are five characteristics from which the user can choose, and these are: safety; economy; pollution; “hot spots”; and congestion. Each of the five characteristics have a tick box 1202 associated with them in order that a user can indicate that the characteristic should be used by clicking a mouse (or otherwise indicating to the computer) in the box 1202. In this embodiment a tick has been placed in the box for safety, pollution and “hot spots”. Further, in this embodiment, the characteristic “hot spots” has two sub-characteristics: schools and road works with associated tick boxes 1204. The sub-characteristics enable a user to further refine how the report is generated. It will be appreciated that any of the other characteristics may also have sub-characteristics that can be expanded to provide more detail where required.

The embodiment shown in FIG. 22 provides a fine granularity when considering how the driver profile should be considered, so that a user can modify the profile/report to their individual needs.

FIG. 23 shows a system for monitoring how much pollution is produced by a vehicle according to an embodiment of the present invention. The system comprises a car 1200 and a remote computer 1206. This system is particularly concerned with generating a pollution profile that indicates how much pollution is produced for one or more journeys, and may be used to reward or penalise a driver based upon how much pollution is produced while they are driving. This system can be used to encourage drivers to produce less pollution.

The car 1200 comprises a transmitter 1205 that is arranged to transmit data recorded by the engine management system (or any other data retrieval device) to the remote computer 1206. In this embodiment there is no GPS associated with the car 1200, as the position of the car 1200 does not directly influence the amount of pollution that is produced. In other embodiments a position determining system may be associated with the car 1200.

The transmitter 1205 transmits data relating to one, some, or all, of the parameters discussed in relation to FIGS. 5 to 13 to the remote computer 1206. The remote computer 1206 then generates a driver profile indicating the driving style of the driver based upon the data recorded by the engine management system. The driver profile is then used to generate the pollution profile.

In some embodiments the processor 1208 and/or memory 1210 may be located within the car 1200 itself, and it is not necessary for the transmitter 1205 to transmit the data recorded by the engine management system to an off-car computer 1206. It may also be possible in some embodiments for a processor within the car 1200 to analyse the data and produce a report to the driver indicating how much pollution the car 1200 is producing while they are driving. The report may be available to the driver in real-time as they are driving so that they have the opportunity to improve their driving in real-time. In other embodiments the report may be available at the end of a journey or periodically, for example every week, month, year, or at any other time. In some embodiments the report may be available to the user on demand.

FIG. 24 shows a pollution profile 1300 according to an embodiment of the present invention. The pollution profile 1300 is a report that gives a score as to how well the vehicle is being driven in relation to minimising pollution. In this case the score is 70%, although any other scoring mechanism may be used. The report also provides more constructive comments as to why a large amount of pollution is being produced, and what a driver can do to reduce the amount of pollution being produced.

For example, the report may indicate that pollution is being generated because the driver is accelerating harshly, revving the engine a lot, using the wrong gear, driving too quickly, etc.

It will be appreciated that a pollution profile may also be generated as part of the feedback for any of the earlier embodiments of the invention.

In some embodiments only one driver may be allowed to drive a certain vehicle, for example, only one person may be insured for the vehicle. Therefore data returned by a vehicle can be associated with the only driver that is allowed to drive that vehicle.

In other embodiments more than one person may be insured to drive the same vehicle, and an identification means or device may be required to determine which person is driving the vehicle at a given time/for a given journey, and therefore with whom the recorded data should be associated.

The identification means may be a magnetic identification key, for example a dallas key, that can be placed adjacent to a reader when a new driver starts to drive the vehicle. Alternatively, a driver may identify themselves to the system at the start of each journey, or each time the engine is started. The driver may also identify themselves at the end of each journey.

In other embodiments, a smart card in combination with a smart card reader may be used to identify the driver.

The driver identification can be very useful to ensure that the correct driver is rewarded or penalised. In embodiments where a driver may be penalised/disciplined for breaking the law, for example by exceeding a speed limit, it may be particularly important that the correct driver can be identified.

It will be appreciated that any of the features defined by the dependent claims, and any of the non-essential features of the invention, could be used with any of the features defined by any of the other claims or any of the embodiments or aspects of the invention.

1. A method for determining insurance costs for a driver of a vehicle comprising:
monitoring the location of the vehicle whilst it is being driven by the driver;
monitoring parameters associated with the vehicle whilst it is being driven by the driver;
generating a driver profile that indicates the driving style of the driver based upon the location of the vehicle and the parameters associated with the vehicle whilst it is being driven; and
determining insurance costs or charges using the driver profile.

2. The method of claim 1 wherein the location of the vehicle and the style in which the vehicle is being driven are monitored in real-time.

3. The method of claim 2 the insurance costs or charges are generated in real-time.

4. The method of claim 1 wherein monitoring the style in which the vehicle is being driven comprises monitoring at least one of:
i) the revolution speed of the engine;
ii) the speed of the vehicle;
iii) the acceleration of the vehicle;
iv) the deceleration of the vehicle;
v) the throttle position of the vehicle;
vii) the gear the vehicle is being driven in;
vii) the gear ratio the vehicle is being driven in;
viii) the idle ratio the vehicle is being driven in;
ix) the fuel consumption/usage of the vehicle;
x) miles per gallon (mpg);
xi) any faults associated with the vehicle; and
xii) any combination of i) to xi).

5. The method of claim 4 wherein monitoring the style in which the vehicle is being driven comprises recording data relating to at least one of i) to ix) in a range of values.

6. The method of claim 5 wherein the insurance costs or charges are set for mileage driven within at least one of the range of values.

7. The method of any one of claim 1 wherein the insurance costs or charges are for a specified journey, or wherein the insurance costs or charges are for a number of pre-purchased miles.

8. The method of claim 1 wherein the insurance costs includes a static charge for when the vehicle is stationary.

9. The method of claim 8 wherein the static charge is calculated depending upon where the vehicle is stationary.

10. The method of claim 1 further comprising determining driving conditions experienced by the vehicle at locations where the vehicle is driven, wherein the driving conditions include one or more of:
speed limits;
road works;
proximity to certain buildings/amenities/facilities such as schools, hospitals, or town centres;
accidents;
temporary speed limits;
special events;
weather conditions;
congestion levels;
any combination of (i) to (viii).

11. The method of claim 10 wherein a database is accessed to provide information on the driving conditions present at locations where the vehicle is driven.

12. The method of claim 1 further comprising updating the driver profile at a time chosen from:
at the end of each journey;
daily;
weekly;
monthly;
quarterly;
at the end of the calendar year;
at the end of the fiscal year; or
further comprising displaying a plurality of insurance costs or charges to a user, wherein the plurality of insurance costs or charges are associated with a plurality of insurance companies.

13. The method of claim 1 wherein the parameters associated with the vehicle whilst it is being driven are obtained from an Onboard Diagnostics Interface (OBD).

14. The method of claim 13 wherein Diagnostic Trouble Codes (DTCs) produced by the OBD are used to generate the driver profile.

15. A system for determining insurance costs or charges for a driver of a vehicle comprising:
a vehicle positioning device for monitoring the location of the vehicle whilst it is being driven by the driver;
a device for monitoring parameters associated with the vehicle whilst it is being driven by the driver; and
a processor arranged to:
generate a driver profile that indicates the driving style of the driver based upon the location of the vehicle and the parameters associated with the vehicle whilst it is being driven; and
determine insurance costs or charges using the driver profile.

16. A method for calculating pollution charges for a driver comprising:
monitoring parameters associated with the vehicle whilst it is being driven by the driver;
generating a driver profile that indicates the driving style of the driver based upon the location of the vehicle and the parameters associated with the vehicle whilst it is being driven; and
determining pollution charges using the driver profile.

17. The method of claim 16 wherein the pollution charges are predicted future pollution charges based on the driver profile.
